(19) United States
(12) Patent Application Publication
(10) Pub. No.: US 2009/0165588 A1
(43) Pub. Date: Jul. 2, 2009

(54) GEAR ROTATION TRANSMISSION DEVICE

(75) Inventors: Takahiro YASUDA, Toyota-shi (JP); Tatsuo KUBOTA, Hekinan-shi (JP)

Correspondence Address: SUGHRUE MION, PLLC, 2100 PENNSYLVANIA AVENUE, N.W., SUITE 800, WASHINGTON, DC, 20037, US

(73) Assignee: AISIN AW CO., LTD., Anjo-shi (JP)

(21) Appl. No.: 12/343,369

(22) Filed: Dec. 23, 2008

(30) Foreign Application Priority Data
Dec. 27, 2007 (JP) 2007-336201

(51) Int. Cl. F16H 57/04

(52) U.S. Cl. 74/467

(57) ABSTRACT

Since lubricating oil is injected to a tooth of a small-diameter helical gear immediately before meshing begins, the injected lubricating oil can be captured between the small-diameter helical gear and a large-diameter helical gear and successively flow along meshing tooth surfaces. Therefore, lubrication of the tooth surface and cooling of the tooth surface can be simultaneously performed with an appropriate quantity of lubricating oil to enable a reduction in tooth surface wear and a longer gear life. Moreover, a lubricating oil film formed on the tooth surface makes it possible to prevent direct contact between the tooth surfaces of both the small-diameter helical gear and the large-diameter helical gear. Since a covered tooth surface effect is also obtained, the occurrence of pitching and scoring can be suppressed. By injecting lubricating oil directly to the small-diameter helical gear, which has a small heat capacity, a cooling effect thus obtained can suppress a temperature increase of the small gear. Moreover, the occurrence of tooth damage such as pitching and scoring caused by a temperature increase can also be greatly suppressed.

### INCORPORATION BY REFERENCE

The disclosure of Japanese Patent Application No. 2007-336201 filed on Dec. 27, 2007 including the specification, drawings and abstract is incorporated herein by reference in its entirety

### BACKGROUND OF THE INVENTION

1. Field of the Invention

The present invention relates to a gear rotation transmission device that transmits reciprocal gear rotation. More specifically, the present invention relates to a gear rotation transmission device that supplies lubricating oil between reciprocal helical gears.

2. Description of the Related Art

Gear rotation transmission devices in current use are described in Japanese Patent Application Publication Nos. JP-A-H10-122310, JP-A-H11-337449, and JP-A-2002-340152.

According to Japanese Patent Application Publication No. JP-A-H10-122310, a gear device having at least one pair of gears is provided with a lubricating oil supply pipe disposed on an opposite meshing side of a gear. Further a lubricating oil supply pipe that supplies lubricating oil from a central part of a tooth width to a latter half region is provided on a tooth meshing side. With this structure, there is little increase in the heat generated due to oil stirring loss, and the tooth surface, which specifically generates a high temperature and spans from the central part of the tooth to a latter half of a mesh ending part, is well lubricated and cooled. The seizure and wear limits of the tooth surface are thus improved.

According to Japanese Patent Application Publication No. JP-A-H11-337449, a temperature measurement device is arranged on a side opposite to where a gear pair meshes, which directly measures a temperature of the lubricating oil discharged from a mesh part and detects a sign of a seizure of a tooth surface. Appropriate measures for load reduction, increasing oil supply quantity, regulating oil supply temperature and the like thus prevent damage from growing worse and allow the continued operation of a gear apparatus.

According to Japanese Patent Application Publication No. JP-A-2002-340152, a slower gear speed is accompanied by an increase in lubricating oil supply quantity by a first lubricating oil supply nozzle, which supplies lubricating oil to an engagement part by a gear at an engaging side thereof, and is also accompanied by a decrease in a lubricating oil supply quantity from a second lubricating oil supply nozzle that supplies lubricating oil to an engagement part of the gear at the opposite side. Supplying lubricating oil from the engaging side lubricates the gear, while also eliminating extra supply from the opposite side, thereby enabling improved pump efficiency and a smaller pump.

In the case of Japanese Patent Application Publication Nos. JP-A-H10-122310, JP-A-H11-337449, and JP-A-2002-340152, however, for a gear with a varied gear ratio such a final gear of an automobile transmission, a nozzle for supplying lubricating oil must be moved according to the movement of a mesh position, or used interchangeably depending on the variation.

When supplying lubricating oil from the meshing side of the gear, there is a risk of reduced efficiency due to the stirring loss of the gear and so forth. Further, supplying oil from the opposite meshing side may result in insufficient lubricating oil as centrifugal forces fling some lubricating oil outward. As a consequence, gear damage such as gear seizure and accompanying pitching could occur.

The methods in the above Japanese Patent Application Publication Nos. JP-A-H10-122310 and JP-A-2002-340152 intend to resolve these issues by supplying lubricating oil from both the meshing side and the opposite meshing side; however, this magnifies the work load of the pump action due to meshing. Additionally, more lubricating oil than necessary is supplied, which increases the stirring loss as mentioned above.

In particular, supplying oil from the meshing side of the tooth for gears that rotate at high speed in particular can lead to problems such as an increased stirring loss caused by pump action that traps oil in tooth crowns and backside gaps and by an increase in work load known as lubricating oil acceleration, where lubricating oil is accelerated to a peripheral speed. Additionally, the efficiency of the gear device may drop, and an increase in heat may lower the durability limit.

Supplying oil from the opposite meshing side as described above was a common practice especially for gear devices that rotate at high speed. In such case, the supply of oil from the opposite meshing side is intended to cool the tooth surface. However, lubrication of the tooth surface is only performed by lubricating oil adhered to the tooth and an oil mist sucked into the meshing side. According to such methods, lubricating oil is insufficiently supplied to meshing tooth surfaces; especially in a vicinity from the central part of the tooth width to the latter half of a mesh ending part, the temperature increases and there is insufficient oil for lubricating the tooth surfaces. For example, gears that rotate at high speed are highly likely to experience tooth surface damage such as seizure and wear. The adoption of a method that supplies lubricating oil from both the meshing side and the opposite meshing side as a countermeasure for such tooth surface damage as seizure and wear leads to an increase in the work load of the pump action and greater loss as previously mentioned, as well as the problem of stirring loss because more lubricating oil than necessary is supplied. For automobile transmissions in particular where lubricating oil is supplied in accordance with a meshing position that varies for each gear ratio, either the nozzle position must be moved or the nozzle setting modified.

Exemplary embodiments may address the above discussed problems or may address other problems not discussed above. However, an exemplary embodiment need not address these problems or any other problems.

### SUMMARY OF THE INVENTION

Hence, the exemplary embodiments of the present invention were devised in order to address such problems, and provide a gear rotation transmission device that may be capable of sufficiently supplying lubricating oil to a meshing tooth surface and preventing the occurrence of tooth damage such as wear, even for a gear rotating at high speed. It is a further object of the present invention to provide a gear rotation transmission device that does not require movement of a nozzle position even if a gear ratio is changed.

A gear rotation transmission device according to a first aspect meshes a small-diameter helical gear with a large-diameter helical gear and transmits a rotation thereof, wherein a face width of the small-diameter helical gear is wider than a face width of the large-diameter helical gear, and lubricating oil is injected and supplied to a start-of-meshing tooth end, where meshing begins with respect to a tooth of the small-diameter helical gear formed in a helix configuration (a tooth having an inclined spiral direction and helix angle), immediately before such meshing begins.

Here, a gear ratio of the small-diameter helical gear and the large-diameter helical gear is not particularly specified beyond the face width of the small-diameter helical gear being wider than the face width of the large-diameter helical gear.

Lubricating oil is injected and supplied to a start-of-meshing tooth end where meshing begins with respect to an outermost tip of a tooth of the small-diameter helical gear formed in a helix configuration, immediately before such meshing begins. Lubricating oil is preferably injected and supplied to the start-of-meshing tooth end where the outermost tip of the tooth surface prior to the start of meshing begins to mesh.

A position at which lubricating oil is injected and supplied with respect to the tooth of the small-diameter helical gear is on the start-of-meshing tooth end side where meshing of the small-diameter helical gear begins, and the position at which such injection and supply is received is set so as to be at least partially or entirely located outside of the face width of the large-diameter helical gear and can serve as a meshing position of the tooth width of the large-diameter helical gear.

According to a second aspect, for the injection and supply of lubricating oil to a tooth of the small-diameter helical gear, lubricating oil is injected from a nozzle provided on an end face side of the large-diameter helical gear.

Here, the end face side of the gear provided with the nozzle that injects and supplies lubricating oil is preferably positioned at the start-of-meshing tooth end, where the outermost tip of the tooth surface prior to the start of meshing begins to mesh, can be arranged generally horizontal.

For the injection and supply of lubricating oil to a tooth of the small-diameter helical gear of the gear rotation transmission device according to a third aspect, a pipe arranged along the end face of the large-diameter helical gear guides lubricating oil supplied from an oil pump to inject and supply the guided lubricating oil in a generally orthogonal direction from the pipe.

Here, the pipe arranged along the end face side of the large-diameter helical gear is parallel to the end face of the large-diameter helical gear. The pipe injects lubricating oil to the small-diameter helical gear, and injects in a generally orthogonal direction to the start-of-meshing tooth end, where the outermost tip of the tooth surface prior to the start of meshing begins to mesh.

Regarding the small-diameter helical gear and the large-diameter helical gear of the gear rotation transmission device according to a fourth aspect, the small-diameter helical gear is a driving gear and the large-diameter helical gear is a driven gear. Here, if the small-diameter helical gear is the driving side, then the lubricating oil to be supplied is supplied to an upper surface side of the tooth at which meshing begins, and such lubricating oil is pressed against and supplied to an upper surface side of the large-diameter helical gear, which is the driven side.

According to a fifth aspect, in the gear rotation transmission device, lubricating oil is injected at a tooth end where meshing of the small-diameter helical gear and the large-diameter helical gear begins, in a direction generally parallel to a line connected between two axes of both gears. Here, the injection of lubricating oil from a direction generally parallel to the line connected between the two axes of both gears refers to injecting lubricating oil from a linear direction that is generally parallel or a linear direction that is parallel to a line in a direction simultaneously orthogonal to both axes of the gears. However, such injection can also be achieved by injecting lubricating oil from a position that overlaps with a line connected between the two axes of both gears, by injecting lubricating oil from a linear position moved in parallel from the line between the two axes of both gears, and by injecting at a slight angle with respect to the line between the two axes of both gears.

In the gear rotation transmission device according to a sixth aspect, a position at which lubricating oil is injected and supplied with respect to the tooth of the small-diameter helical gear is on the start-of-meshing tooth end side where meshing of the small-diameter helical gear begins, and the position at which such injection and supply is received is at least partially or entirely located outside of the face width of the large-diameter helical gear.

Here, the position at which lubricating oil is injected and supplied to the tooth of the small-diameter helical gear is located at least partially or entirely at a meshing position of the small-diameter helical gear with the large-diameter helical gear.

In the gear rotation transmission device according to the first aspect, the face width of the small-diameter helical gear is wider than the face width of the large-diameter helical gear, and lubricating oil is injected and supplied to a start-of-meshing tooth end where meshing begins with respect to a tooth of the small-diameter helical gear formed in a helix configuration, immediately before such meshing begins.

Accordingly, since lubricating oil is injected immediately before meshing begins, the injected lubricating oil can be captured between the small-diameter helical gear and the large-diameter helical gear and successively flow along the meshing tooth surfaces. Therefore, lubrication of the tooth surface and cooling of the tooth surface can be simultaneously performed with an appropriate quantity of lubricating oil to enable a reduction in tooth surface wear and improved gear durability.

Moreover, a lubricating oil film formed on the tooth surfaces makes it possible to prevent direct contact between the tooth surfaces of both gears. Since a covered tooth surface effect is also obtained, the occurrence of pitching and scoring can be suppressed. By injecting lubricating oil directly to the small-diameter helical gear, which has a small heat capacity, a cooling effect thus obtained can suppress a temperature increase of the small gear. Moreover, the occurrence of tooth damage such as pitching and scoring caused by a temperature increase can also be greatly suppressed.

Furthermore, lubricating oil is injected generally parallel to a line between the two axes of both gears. Accordingly, there is no need to change or move the nozzle, and one type of nozzle or a hole opened in a pipe can thus be used for various gear ratios.

As a consequence, even for gears rotating at high speed, sufficient lubricating oil can be supplied to the meshing tooth surfaces and the occurrence of tooth surface damage such as wear can be prevented. In addition, there is no need to move the nozzle position regardless of whether the gear ratio is changed.

Regarding the injection and supply of lubricating oil to the tooth of the small-diameter helical gear of the gear rotation transmission device according to the second aspect, lubricating oil is injected from the nozzle provided on an end face side of the large-diameter helical gear. Therefore, in addition to the effect of the first aspect, such lubricating oil directly impacts the small-diameter helical gear. Even if the lubricating oil is not captured between the small-diameter helical gear and the large-diameter helical gear, this in turn can contribute to cooling of the small-diameter helical gear, which has a small heat capacity, and also enables the efficient use of lubricating oil.

Further regarding the injection and supply of lubricating oil to the tooth of the small-diameter helical gear of the gear rotation transmission device according to the third aspect, the nozzle arranged along the end face of the large-diameter helical gear guides lubricating oil supplied from the oil pump to inject and supply lubricating oil in a generally orthogonal direction from the nozzle. Therefore, in addition to the effect of the first aspect wherein lubricating oil is injected and supplied at the start-of-meshing tooth end where meshing begins with respect to a tooth of the small-diameter helical gear formed in a helix configuration, oil is also supplied to a clearance between the small-diameter helical gear and the large-diameter helical gear immediately before such meshing begins. Because the clearance becomes successively narrower, lubricating oil moves freely along the tooth surface. A larger quantity of lubricating oil is thus captured between the reciprocating gears for a more efficient supply of lubricating oil.

Still further regarding the small-diameter helical gear and the large-diameter helical gear of the gear rotation transmission device according to the fourth aspect, the small-diameter helical gear is the driving side and the large-diameter helical gear is the driven side. Therefore, in addition to the effect described in any one of the first to third aspects, it is possible to repeatedly move captured lubricating oil along the tooth surface to an end of meshing away from the start-of-meshing tooth end where meshing begins. Accordingly, the cooling efficiency of the small-diameter helical gear, which has a small heat capacity, can be raised.

Regarding the small-diameter helical gear and the large-diameter helical gear of the gear rotation transmission device according to the fifth aspect, lubricating oil is injected in a direction generally parallel to a line connected between two axes of both gears. Therefore, in addition to the effect described in any one of the first to fourth aspects, there is no need to change or move the nozzle due to the injection of lubricating oil from a direction generally parallel to the line connected between the two axes of both the small-diameter helical gear and the large-diameter helical gear. One type of nozzle or pipe opened with a hole can thus be used for various gear ratios. There is thus no need to move the nozzle position regardless of whether the gear ratio is changed.

In the gear rotation transmission device according to the sixth aspect, the position at which lubricating oil is injected and supplied with respect to the tooth of the small-diameter helical gear is on the start-of-meshing tooth end side where meshing of the small-diameter helical gear begins. Accordingly, the position at which such injection and supply is received is at least partially or entirely located outside of the face width of the large-diameter helical gear. Therefore, in addition to the effect of any one of the first to fourth aspects, cooling of the entire small-diameter helical gear can be achieved and the quantity of lubricating oil can be increased, thus making it possible to secure a quantity of lubricating oil flowing over the tooth surface and cover the tooth surface with lubricating oil during meshing, which can prevent wear.

### BRIEF DESCRIPTION OF THE DRAWINGS

FIG. 1 is an explanatory drawing of a gear rotation transmission device according to an exemplary embodiment of the present invention as viewed from the front;

FIG. 2 is an explanatory drawing of the gear rotation transmission device according to the exemplary embodiment of the present invention as viewed from a plane in FIG. 1;

FIG. 3 is a perspective view of an essential portion of the gear rotation transmission device according to the exemplary embodiment of the present invention; and

FIG. 4 is a cross-sectional view of an embodiment in which the gear rotation transmission device according to the exemplary embodiment of the present invention is used as an automatic transmission for an automobile.

### DETAILED DESCRIPTION OF THE EXEMPLARY EMBODIMENTS

Embodiments of the present invention will be described below with reference to the drawings. Note that like symbols and like reference numerals in the drawings denote like or equivalent functional portions, so duplicate descriptions will be omitted here.

### First Embodiment

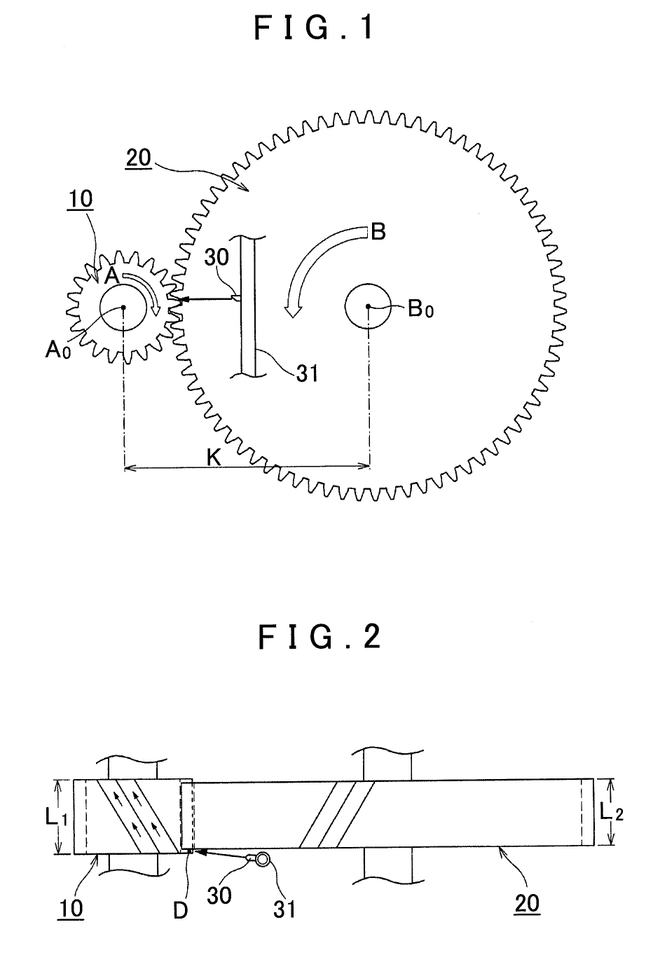

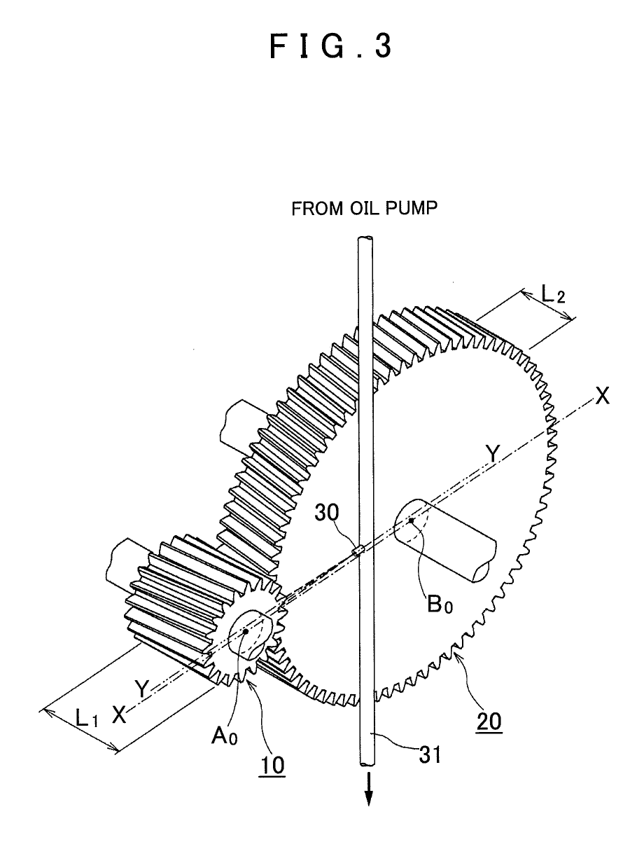

FIG. 1 is an explanatory drawing of a gear rotation transmission device according to a first embodiment of the present invention as viewed from the front. FIG. 2 is an explanatory drawing of the gear rotation transmission device according to the first embodiment of the present invention as viewed from a plane in FIG. 1. FIG. 3 is a perspective view of an essential portion of the gear rotation transmission device according to the first embodiment of the present invention.

In FIGS. 1 to 3, a small-diameter helical gear 10 and a large-diameter helical gear 20 form a gear rotation transmission mechanism that mutually meshes the gears and transmits a rotation thereof. The small-diameter helical gear 10 and the large-diameter helical gear 20 are formed with teeth shaped into a helix configuration, that is, teeth with a predetermined helix angle and spiral direction. In the present invention, a gear ratio of the small-diameter helical gear 10 and the large-diameter helical gear 20 is not particularly specified beyond the small-diameter helical gear 10 and the large-diameter helical gear 20 having a small-large relationship. However the helical gear 10 and the helical gear 20 may also share the same diameter and sharing the same diameter does not mean that the present invention cannot be carried out; however, an effect is achieved when the small-diameter helical gear 10 and the large-diameter helical gear 20 have different diameters.

The small-diameter helical gear 10 rotates in the direction of an arrow A in FIG. 1, and guides the rotation of the large-diameter helical gear 20 in the direction of an arrow B in FIG. 1. The teeth of the small-diameter helical gear 10 and the large-diameter helical gear 20 mutually engage and mesh such that upper sides of the small-diameter helical gear 10 and the large-diameter helical gear 20 wind together and rotation is transmitted from the small-diameter helical gear 10 to the large-diameter helical gear 20.

Referring to FIG. 2, the teeth of the small-diameter helical gear 10 have a helix angle of approximately 30 degrees and a rightward spiral direction (a tooth trace that slopes upward from left to right), while the teeth of the large-diameter helical gear 20 have a helix angle of approximately 30 degrees and a leftward spiral direction (a tooth trace that slopes upward from right to left). A face width L1 of the small-diameter helical gear 10 is also slightly wider than a face width L2 of the large-diameter helical gear 20, specifically by about 1 to 10 millimeters.

With respect to the face width L1 of the small-diameter helical gear 10 being wider than the face width L2 of the large-diameter helical gear 20, a nozzle 30 is set so as to inject lubricating oil along an injection path Y-Y that is generally parallel to a line X-X of a distance K connected between respective axes A₀, B₀ of the small-diameter helical gear 10 and the large-diameter helical gear 20. The nozzle 30 injects lubricating oil that is supplied via a pipe 31 from an oil pump of an automatic transmission (not shown). An injection position is at a start-of-meshing tooth end D where meshing begins with respect to a tooth of the small-diameter helical gear 10 formed in a helix configuration, and lubricating oil is injected to the tooth of the small-diameter helical gear 10 immediately before such meshing begins.

Note that the nozzle 30 has a guiding function that identifies the injection direction of lubricating oil to obtain the injection path Y-Y. However, due to the high pressure of the oil pump of the automatic transmission, injection in the horizontal direction of FIG. 1 is easy to obtain, and it is therefore possible to provide a hole in the pipe 31 instead. In other words, the pump pressure enables a hole provided in the pipe 31 to serve as a nozzle.

The nozzle 30 is set so as to inject lubricating oil along the injection path Y-Y onto the tooth end D, which is on a lower side of the rightward spiral direction (a tooth trace that slopes upward from left to right) of FIG. 2. Thus, lubricating oil can be injected along the injection path Y-Y generally parallel to the line X-X connecting the axes A₀, B₀ at the start-of-meshing tooth end D where meshing begins with respect to a tooth of the small-diameter helical gear 10 formed in a helix configuration. This can be achieved regardless of any variation in the distance K connected between the respective axis A₀ and axis B₀ of the small-diameter helical gear 10 and the large-diameter helical gear 20, that is, regardless of whether the diameters of the small-diameter helical gear 10 and the large-diameter helical gear 20 change and whether a gear ratio for changing a shift speed within the automatic transmission of an automobile changes.

Regarding the injection and supplying of lubricating oil for the teeth of the small-diameter helical gear 10 according to the present embodiment, lubricating oil is injected from the nozzle 30 provided on an end face side of the large-diameter helical gear 20, and therefore such lubricating oil directly impacts the small-diameter helical gear 10. Even if the lubricating oil is not captured between the small-diameter helical gear 10 and the large-diameter helical gear 20, the lubricating oil steals heat from the small-diameter helical gear 10 due to the impact with the small-diameter helical gear 10. This in turn can contribute to cooling of the small-diameter helical gear 10, which has a small heat capacity, and also enables the efficient use of lubricating oil.

Further regarding the injection and supply of lubricating oil to the teeth of the small-diameter helical gear 10, the pipe 31 arranged along an end face of the large-diameter helical gear 20 guides lubricating oil supplied from the oil pump (not shown) to inject and supply lubricating oil in a generally orthogonal direction from the nozzle 30 of the pipe 31. Therefore, lubricating oil is injected and supplied at the start-of-meshing tooth end D, where meshing begins with respect to a tooth of the small-diameter helical gear 10 formed in a helix configuration, and into a clearance between the small-diameter helical gear 10 and the large-diameter helical gear 20 immediately before such meshing begins. Regarding this clearance, a contact position changes successively from a lower side to an upper side in FIG. 2 as a result of rotation, and a contact point moves successively in a tooth width direction. Therefore, lubricating oil moves freely along the tooth surface formed in a helical configuration. A larger quantity of lubricating oil is thus captured between the reciprocating gears for a more efficient supply of lubricating oil, and a cooling efficiency is improved as well due to the free movement of lubricating oil along the tooth surface.

With respect to the small-diameter helical gear 10 and the large-diameter helical gear 20, where the small-diameter helical gear 10 is the driving side and the large-diameter helical gear 20 is the driven side, it is possible to repeatedly move captured lubricating oil along the tooth surface to an end of meshing from the start-of-meshing tooth end D, where meshing begins. Accordingly, the cooling efficiency of the small-diameter helical gear 10, which has a small heat capacity, can be raised. Moreover, a lubricating oil film formed on the tooth makes it possible to avoid contact between metal faces of the small-diameter helical gear 10 and the large-diameter helical gear 20, which reduces wear on the gears.

Furthermore, lubricating oil is injected along the injection path Y-Y generally parallel to the line X-X between the two axes of both the small-diameter helical gear 10 and the large-diameter helical gear 20. Accordingly, there is no need to change or move the nozzle 30 due to injection along the injection path Y-Y generally parallel to the line X-X between the two axes of both gears, i.e., the respective axes A₀, B₀. One type of nozzle 30 (or hole of the pipe 31) can thus be used for various gear ratios.

Regarding the injection direction of the nozzle 30, as the gear ratio of the small-diameter helical gear 10 and the large-diameter helical gear 20, namely, a [small-diameter helical gear 10]/[large-diameter helical gear 20] value, increases, a meshing position of both gears moves slightly upward. However, the position setting of the injection direction of the nozzle 30 can be corrected by setting the injection along the injection path Y-Y generally parallel to the line X-X between the two axes of both gears, i.e., between the respective axes A₀, B₀, above the line X-X between the two axes, or inclining the injection downward by a few degrees as necessary. However, if the injection direction of the injection path Y-Y is set above the line X-X between the two axes, then the additional correction of inclining the nozzle 30 downward by a few degrees or the lack thereof has very little impact. In other words, the impact is very small because the injection path Y-Y is a parabola rather than a line due to the pump pressure.

In this manner of supplying lubricating oil to the teeth of the small-diameter helical gear 10, the pipe 31 arranged along the end face of the large-diameter helical gear 20 guides lubricating oil supplied from the oil pump (not shown) to inject and supply lubricating oil from the nozzle 30 disposed on the pipe 31 in a generally orthogonal direction thereof.

With respect to the small-diameter helical gear 10 and the large-diameter helical gear 20, the small-diameter helical gear 10 is the driving side and the large-diameter helical gear 20 is the driven side. Therefore, lubricating oil is injected and supplied at the start-of-meshing tooth end D, where meshing begins with respect to a tooth of the small-diameter helical gear 10 formed in a helix configuration, to a clearance between the small-diameter helical gear 10 and the large-diameter helical gear 20 immediately before such meshing begins. Accordingly, successive meshing of the clearance results in the movement of lubricating oil in the direction of a meshing end face along tooth surfaces of the small-diameter helical gear 10 and the large-diameter helical gear 20 formed in a helix configuration. In particular, between the small-diameter helical gear 10 and the large-diameter helical gear 20, the tooth surface of the small-diameter helical gear 10 on the driving side applies a pressing force to the driven side, while lubricating oil captured between the reciprocating gears is taken in from the meshing side and flows in the tooth width direction. Moreover, there is an increased quantity of lubricating oil allowing more efficient supplying of lubricating oil, and the cooling efficiency is improved as well due to the free movement of lubricating oil along the tooth surface.

According to the present embodiment, lubricating oil is not supplied from an opposite meshing side and therefore cooling is not simply performed by supplying lubricating oil to contact the tooth surface. In other words, according to a conventional method of supplying lubricating oil from the opposite meshing side, the quantity of lubricating oil on the tooth surface consists only of lubricating oil adhered to the tooth and an oil mist taken in from the meshing side. However, in the present embodiment, there is a larger quantity of lubricating oil for a more efficient supply of lubricating oil, and the cooling efficiency is improved as well due to the free movement of lubricating oil along the tooth surface. Naturally there maybe less insufficiency of lubricating oil for lubricating the tooth surface that consequently results in a high temperature, and less tooth surface damage such as seizure and wear.

### Second Embodiment

The gear rotation transmission device according to the embodiment of the present invention formed as described above can be utilized as follows as a drive unit of an automatic transmission for an automobile, for example.

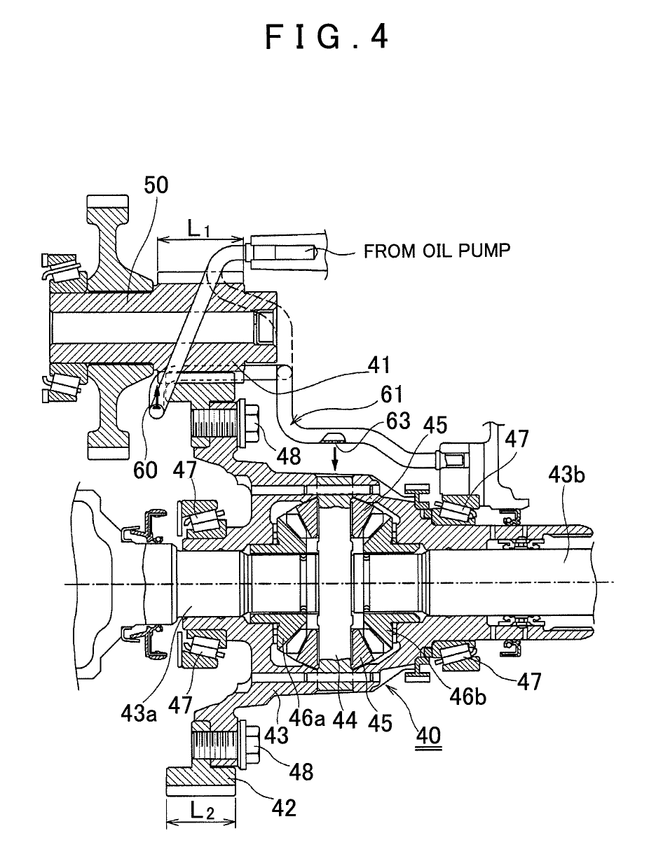

FIG. 4 is an embodiment in which the gear rotation transmission device according to the above embodiment of the present invention is used as a drive unit of an automatic transmission or the like for an automobile.

In the figure, a drive unit for an automatic transmission or the like according to a second embodiment of the present invention is suited for use in a transverse front engine, front wheel drive (FF type) vehicle. The drive unit is provided between a pair of drive wheels (front wheels) and an engine serving as a driving power source for running. The drive unit transmits power to the drive wheels (front wheels, not shown) via a differential (differential gear unit) 40, a pair of axles 43a, 43b, and the like.

In order to uniformly distribute torque while allowing a difference in rotation between the pair of drive wheels (front wheels), the differential gear unit 40 includes the following: a differential ring gear 42 formed from a large-diameter helical gear rotatably disposed on an axis center parallel to an axis center of an input shaft 50, which uses the engine as a driving source and to which rotation from a torque converter is input; a differential case 43 that rotates with the differential ring gear 42; a pair of small differential gears 45 rotatably supported around an axis center orthogonal to an axis center of the pair of axles 43a, 43b by a vertical shaft 44 fixed to the differential case 43; and large differential gears 46a, 46b that are axially supported by the axles 43a, 43b and mesh with the small differential gears 45.

The differential case 43 is rotatably supported by a case (not shown) via a necessary number of bearings 47. The differential ring gear 42 is integratedly fixed to the differential case 43 by a predetermined number of bolts 48.

A differential drive pinion gear 41 formed from a small-diameter helical gear meshes with the differential ring gear 42, which is axially supported by the input shaft 50 to which rotation from the torque converter is input. In other words, the differential drive pinion gear 41 of the second embodiment corresponds to the small-diameter helical gear 10 of the first embodiment, and the differential ring gear 42 similarly corresponds to the large-diameter helical gear 20.

With respect to a face width L1 of the differential drive pinion gear 41 being wider than a face width L2 of the differential ring gear 42, a nozzle 60 formed from a pipe hole is set so as to inject lubricating oil along an injection path Y-Y that is generally parallel to a line X-X shown in FIG. 3 between respective axes of the differential drive pinion gear 41 and the differential ring gear 42. The nozzle 60 injects lubricating oil that is supplied via a pipe 61 from an oil pump of an automatic transmission (not shown). An injection position is at a start-of-meshing tooth end where meshing begins with respect to a tooth of the differential drive pinion gear 41 formed in a helix configuration, and lubricating oil is injected to the tooth of the differential drive pinion gear 41 immediately before such meshing begins.

Note that the nozzle 60 formed from a pipe hole is a hole provided in the pipe 61, due to the high pressure of the oil pump of automatic transmission. In addition, lubricating oil supplied from the oil pump of the automatic transmission is also supplied via the pipe 61 and a lubricating hole 63 to the vertical shaft 44 fixed to the differential case 43 of the differential gear unit 40.

As explained above, the gear rotation transmission device according to the second embodiment is used as a drive unit of an automatic transmission or the like for an automobile. Accordingly, in a gear rotation transmission device that meshes the differential drive pinion gear 41 and the differential ring gear 42 and transmits a rotation thereof, the face width L1 of the differential drive pinion gear 41 is wider than the face width L2 of the differential ring gear 42. Also, at the start-of-meshing tooth end where meshing begins with respect to a tooth of the differential drive pinion gear 41 formed in a helix configuration, lubricating oil is injected and supplied to the tooth of the differential drive pinion gear 41 immediately before such meshing begins.

Since the face width L1 of the differential drive pinion gear 41 is wider than the face width L2 of the differential ring gear 42, and the start-of-meshing tooth end where meshing begins with respect to a tooth of the differential drive pinion gear 41 is formed in a helix configuration, lubricating oil is injected to the tooth of the differential drive pinion gear 41 immediately before such meshing begins allowing the injected lubricating oil to be captured between the differential drive pinion gear 41 and the differential ring gear 42 and successively flow along the meshing tooth surfaces. Therefore, lubrication of the tooth surface and cooling of the tooth surface can be simultaneously performed with an appropriate quantity of lubricating oil to enable a reduction in tooth surface wear and allowing a longer gear life.

Moreover, a lubricating oil film formed on the tooth surfaces of the differential drive pinion gear 41 and the differential ring gear 42 makes it possible to prevent direct contact between the tooth surfaces of both gears. Since a covered tooth surface effect is also obtained, the occurrence of pitching and scoring can be suppressed. By injecting lubricating oil directly into the differential drive pinion gear 41, which has a small heat capacity, a cooling effect thus obtained can suppress a temperature increase of the small gear. Moreover, the occurrence of tooth damage such as pitching and scoring caused by a temperature increase can also be greatly suppressed.

Furthermore, lubricating oil is injected generally parallel to the line X-X between the two axes of both the differential drive pinion gear 41 and the differential ring gear 42. Accordingly, there is no need to change or move the nozzle 60, and one type of nozzle 30 shown in FIG. 1 or the nozzle 60 that is a hole opened in a pipe can thus be used for various gear ratios. As a consequence, sufficient lubricating oil can be supplied to the meshing tooth surfaces and the occurrence of tooth surface damage such as seizure and wear can be prevented even for gears rotating at high speed. In addition, there is no need to move the nozzle position when the gear ratio is changed.

In other words, similar to the second embodiment, the first embodiment can have a structure in which a gear rotation transmission device meshes the small-diameter helical gear 10 and the large-diameter helical gear 20 and transmits a rotation thereof, and the face width L1 of the small-diameter helical gear 10 is wider than the face width L2 of the large-diameter helical gear 20. Also, at the start-of-meshing tooth end where meshing begins with respect to a tooth of the small-diameter helical gear 10 formed in a helix configuration, lubricating oil is injected and supplied to the tooth of the small-diameter helical gear 10 immediately before such meshing begins.

Accordingly, since lubricating oil is injected to the tooth of the small-diameter helical gear 10 immediately before meshing begins, the injected lubricating oil can be captured between the small-diameter helical gear 10 and the large-diameter helical gear 20 and successively flow along the meshing tooth surfaces. Therefore, lubrication of the tooth surface and cooling of the tooth surface can be simultaneously performed with an appropriate quantity of lubricating oil to enable a reduction in tooth surface wear and a longer gear life. Moreover, a lubricating oil film formed on the tooth surface makes it possible to prevent direct contact between the tooth surfaces of both the small-diameter helical gear 10 and the large-diameter helical gear 20. Since a covered tooth surface effect is also obtained, the occurrence of pitching and scoring can be suppressed.

By injecting lubricating oil directly into the small-diameter helical gear 10, which has a small heat capacity, a cooling effect can be obtained which suppresses a temperature increase of the small gear. Moreover, the occurrence of tooth damage such as pitching and scoring caused by a temperature increase can also be greatly suppressed. Furthermore, lubricating oil is injected generally parallel to the line X-X between the two axes of both gears, i.e., the respective axes A₀, B₀. Accordingly, there is no need to change or move the nozzle 30, and one type of nozzle 30 or a hole opened in a pipe can thus be used for various gear ratios. As a consequence, even for gears rotating at high speed, sufficient lubricating oil can be supplied to the meshing tooth surfaces and the occurrence of tooth surface damage such as wear can be prevented. In addition, there is no need to move a position of the nozzle 30 when the gear ratio is changed.

In the above first embodiment and second embodiment, the injection and supplying of lubricating oil to the teeth of the small-diameter helical gear 10 and the differential drive pinion gear 41 involves injecting lubricating oil from the nozzles 30, 60 provided on the end face sides of the large-diameter helical gear 20 and the differential ring gear 42. Accordingly lubricating oil directly impacts the small-diameter helical gear 10 and the differential drive pinion gear 41. Therefore, even if lubricating oil is not captured between the small-diameter helical gear 10 and the large-diameter helical gear 20 and between the differential drive pinion gear 41 and the differential ring gear 42, the small-diameter helical gear 10 and the differential ring gear 42, which have a small heat capacity, can be cooled while enabling the efficient use of lubricating oil.

In the above first embodiment and second embodiment and further regarding the injection and supply of lubricating oil to the teeth of the small-diameter helical gear 10 and the differential drive pinion gear 41, the nozzles 30, 60 arranged along the end faces of the large-diameter helical gear 20 and the differential ring gear 42 guide lubricating oil supplied from the oil pump to inject and supply lubricating oil in a generally orthogonal direction from the nozzles 30, 60. Therefore, lubricating oil is injected and supplied at the start-of-meshing tooth end, where meshing begins with respect to a tooth of the small-diameter helical gear 10 and the differential drive pinion gear 41 formed in a helix configuration, to a clearance between the small-diameter helical gear 10 and the large-diameter helical gear 20, and between the differential drive pinion gear 41 and the differential ring gear 42, immediately before such meshing begins. Because the clearance becomes successively narrower, lubricating oil moves freely along the tooth surface. A larger quantity of lubricating oil is thus captured between the reciprocating gears for a more efficient supply of lubricating oil.

In the above first embodiment and second embodiment with respect to the small-diameter helical gear 10 and the differential drive pinion gear 41, as well as the large-diameter helical gear 20 and the differential ring gear 42, the small-diameter helical gear 10 and the differential drive pinion gear 41 are the driving side, and the large-diameter helical gear 20 and the differential ring gear 42 are the driven side. It is thus possible to repeatedly move captured lubricating oil along the tooth surface to an end of meshing from the start-of-meshing tooth end where meshing begins. Accordingly, the cooling efficiency of the small-diameter helical gear 10 and the differential drive pinion gear 41, which has a small heat capacity, can be raised.

In the above first embodiment and second embodiment, lubricating oil is injected generally parallel to the line X-X between the two axes of both the small-diameter helical gear 10 and the large-diameter helical gear 20, as well as between the two axes of both the differential drive pinion gear 41 and the differential ring gear 42. Accordingly, there is no need to change or move the nozzles 30, 60 due to the injection of lubricating oil generally parallel to the line X-X between the two axes of both the small-diameter helical gear 10 and the large-diameter helical gear 20, as well as between the two axes of both the differential drive pinion gear 41 and the differential ring gear 42. One type of nozzle 30 or pipe 60 opened with a hole can thus be used for various gear ratios.

In the above first embodiment and second embodiment, the position at which lubricating oil is injected and supplied with respect to the teeth of the small-diameter helical gear 10 and the differential drive pinion gear 41 is on the start-of-meshing tooth end side where meshing of the small-diameter helical gear 10 and the differential drive pinion gear 41 begins. Accordingly, the position at which such injection and supply is received is at least partially or entirely located outside of the face width L2 of the large-diameter helical gear 20 and the differential ring gear 42. Therefore, cooling of the entire small-diameter helical gear 10 and the differential drive pinion gear 41 can be achieved and the quantity of lubricating oil can be increased, thus making it possible to secure a quantity of lubricating oil flowing over the tooth surface and cover the tooth surface with lubricating oil during meshing, which can prevent wear.

In the above first embodiment and second embodiment, examples were described in which a helical gear was utilized as the small-diameter helical gear 10, the large-diameter helical gear 20, the differential drive pinion gear 41, and the differential ring gear 42. With respect to the present embodiment, the face width L1 of the small-diameter helical gear 10 is wider than the face width L2 of the large-diameter helical gear 10, and lubricating oil is injected and supplied at the start-of-meshing tooth end, where meshing begins with respect to the tooth of the small-diameter helical gear 10 formed in a helix configuration, to the tooth of the small-diameter helical gear 10 immediately before such meshing begins. However, based on the above, it is also clear that the present invention may be applied to a double helical gear, whereby the small-diameter helical gear 10 and the large-diameter helical gear 20 are a pair of double helical gears in which the spiral directions of the helical gears are mutually opposed. In such case, lubricating oil is injected and supplied from the start-of-meshing tooth end, where meshing begins from both sides to the tooth of the small-diameter helical gear 10 immediately before such meshing begins.

What is claimed is:

1. A gear rotation transmission device comprising a first helical gear, which meshes with a second helical gear and transmits a rotation thereof, wherein
a face width of the first helical gear is wider than a face width of the second helical gear, and lubricating oil is injected and supplied to a start-of-meshing tooth end, where meshing begins with respect to a tooth of the first helical gear formed in a helix configuration, immediately before such meshing begins.

2. The gear rotation transmission device according to claim 1, wherein a nozzle is provided on an end face of the second helical gear, which injects and supplies lubricating oil to a tooth of the first helical hear.

3. The gear rotation transmission device according to claim 1, wherein a pipe is arranged along the end face of the second diameter helical gear, which guides lubricating oil supplied from an oil pump, which injects and supplies lubricating oil to the tooth of first helical gear in a direction generally orthogonal from the pipe.

4. The gear rotation transmission device according to claim 1, wherein the first helical gear is a driving gear and the second helical gear is a driven gear.

5. The gear rotation transmission device according to claim 1, wherein lubricating oil is injected at a tooth end where meshing of the first helical gear and the second helical gear begins, in a direction generally parallel to a line connecting the two axes of the first and second gears.

6. The gear rotation transmission device according to claim 1, wherein the position at which lubricating oil is injected and supplied with respect to the tooth of the first helical gear is on the start-of-meshing tooth end side where meshing of the first helical gear begins, and the position at which such injection and supply is received is at least one of partially and entirely located outside of the face width of the second helical gear.
